(19) United States
(12) Patent Application Publication
(10) Pub. No.: US 2009/0132314 A1
(43) Pub. Date: May 21, 2009

(54) SYSTEM AND METHOD FOR INCREASING USAGE OF RECYCLING IN MANUFACTURING PROCESSES

(76) Inventor: Lucas G. Franco, Campinas (BR)

Correspondence Address: HOFFMAN WARNICK LLC, 75 STATE ST, 14 FL, ALBANY, NY, 12207, US

(21) Appl. No.: 12/236,535

(22) Filed: Sep. 24, 2008

(30) Foreign Application Priority Data
Sep. 28, 2007 (CA) 2605281

(51) Int. Cl. G06Q 10/00

(52) U.S. Cl. 705/7

(57) ABSTRACT

A system and method for optimizing manufacturing processes to increase usage of recycling in a manufacturing process. In an embodiment, the method comprises: describing a manufacturing process using a plurality of nodes, each node representing a component or a process; connecting the plurality of nodes with directed edges to form a directed graph, the directed graph representing possible manufacturing process flows from a begin node to an end node; assigning to each edge a value representative of the benefit resulting from usage of recycling in a component or process; and determining a longest path from the begin node to the end node in the directed graph to identify a manufacturing process flow maximizing usage of recycling in the manufacturing process.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### FIELD OF THE INVENTION

The present invention relates to systems and methods for increasing usage of recycling in manufacturing processes.

### RELATED ART

Today, people are becoming more aware of the need to reduce the environmental impact of manufacturing processes in order to improve people's health and to ensure long-term sustainability of the environment. One way to achieve this is to increase the use of recycled materials during manufacturing processes. However, the task of maximizing the usage of recycled materials may be difficult, as product manufacturing processes may involve many possible alternatives for components, and for processes that may be used to assemble the components.

### SUMMARY OF THE INVENTION

The present invention relates to a system and method for increasing usage of recycling in manufacturing processes.

In an aspect, there is provided a method of optimizing a manufacturing process to increase usage of recycling in such manufacturing process, comprising: describing the manufacturing process using a plurality of nodes, each node representing a component or a process; connecting the plurality of nodes with directed edges to form a directed graph, the directed graph representing possible manufacturing process flows from a begin node to an end node; assigning to each edge a value representative of a benefit resulting from usage of recycling in a component or process; and determining a longest path from the begin node to the end node in the directed graph to identify a manufacturing process flow maximizing usage of recycling in the manufacturing process.

In an embodiment, the method further comprises: building a cost matrix representing an array of the plurality of nodes, with values in the cost matrix representing the edge values between nodes; inverting the edge values in the cost matrix; and executing a modified Dijkstra's shortest path algorithm, wherein the algorithm is run from the end node instead of the begin node, to determine the longest path from the begin node to the end node in the directed graph.

In another embodiment, the method further comprises identifying the nodes in the longest path, and presenting an ordered combination of any components or processes in the longest path as the solution for maximizing usage of recycling in the manufacturing process.

In another embodiment, the method further comprises modifying the directed graph to incorporate new information by adding or deleting nodes or edges, and by adding or modifying edge values.

In another embodiment, the method further comprises providing a graphical user interface to allow a user to modify the directed graph by adding or deleting node objects or edge objects, and by adding or modifying edge values associated with the edge objects.

In another embodiment, the method further comprises converting the directed graph in the graphical user interface into a new cost matrix.

In another embodiment, the method further comprises re-executing the modified Dijkstra's shortest path algorithm on the new cost matrix to identify the longest path from the begin node to the end node.

In another aspect, there is provided a system for optimizing a manufacturing process to increase usage of recycling in such manufacturing process, comprising: means for describing the manufacturing process using a plurality of nodes, each node representing a component or a process; means for connecting the plurality of nodes with directed edges to form a directed graph, the directed graph representing possible manufacturing process flows from a begin node to an end node; means for assigning to each edge a value representative of a benefit resulting from usage of recycling in a component or process; and means for determining a longest path from the begin node to the end node in the directed graph to identify a manufacturing process flow maximizing usage of recycling in the manufacturing process.

In an embodiment, the system further comprises: means for building a cost matrix representing an array of the plurality of nodes, with values in the cost matrix representing the edge values between nodes; means for inverting the edge values in the cost matrix; and means for executing a modified Dijkstra's shortest path algorithm, wherein the algorithm is run from the end node instead of the begin node, to determine the longest path from the begin node to the end node in the directed graph.

In another embodiment, the system further comprises means for identifying the nodes in the longest path, and presenting an ordered combination of any components or processes in the longest path as the solution for maximizing usage of recycling in the manufacturing process.

In another embodiment, the system further comprises means for modifying the directed graph to incorporate new information by adding or deleting nodes or edges, and by adding or modifying edge values.

In another embodiment, the system further comprises means for providing a graphical user interface adapted to allow a user to modify the directed graph by adding or deleting node objects or edge objects, and by adding or modifying edge values associated with the edge objects.

In another embodiment, the system further comprises means for converting the directed graph in the graphical user interface into a new cost matrix.

In another embodiment, the system further comprises means for re-executing the modified Dijkstra's shortest path algorithm on the new cost matrix to identify the longest path from the begin node to the end node.

In another aspect, there is provided a data processor readable medium storing data processor code that when loaded onto and executed by a data processing device adapts the device to execute a method of optimizing a manufacturing process to increase usage of recycling in such manufacturing process, the data processor readable medium comprising: code for describing the manufacturing process using a plurality of nodes, each node representing a component or a process; code for connecting the plurality of nodes with directed edges to form a directed graph, the directed graph representing possible manufacturing process flows from a begin node to an end node; code for assigning to each edge a value representative of the benefit resulting from usage of recycling in a component or process; and code for determining a longest path from the begin node to the end node in the directed graph to identify a manufacturing process flow maximizing usage of recycling in the manufacturing process.

In an embodiment, the data processor readable medium further comprises: code for building a cost matrix representing an array of the plurality of nodes, with values in the cost matrix representing the edge values between nodes; code for inverting the edge values in the cost matrix; and code for executing a modified Dijkstra's shortest path algorithm, wherein the algorithm is run from the end node instead of the begin node, to determine the longest path from the begin node to the end node in the directed graph.

In another embodiment, the data processor readable medium further comprises code for identifying the nodes in the longest path, and presenting an ordered combination of any components or processes in the longest path as the solution for maximizing usage of recycling in the manufacturing process.

In another embodiment, the data processor readable medium further comprises code for modifying the directed graph to incorporate new information by adding or deleting nodes or edges, and by adding or modifying edge values.

In another embodiment, the data processor readable medium further comprises code for providing a graphical user interface adapted to allow a user to modify the directed graph by adding or deleting node objects or edge objects, and by adding or modifying edge values associated with the edge objects.

In another embodiment, the data processor readable medium further comprises code for converting the directed graph in the graphical user interface into a new cost matrix.

In another embodiment, the data processor readable medium further comprises code for re-executing the modified Dijkstra's shortest path algorithm on the new cost matrix to identify the longest path from the begin node to the end node. These and other aspects of the invention will become apparent from the following more particular descriptions of exemplary embodiments.

### BRIEF DESCRIPTION OF THE DRAWINGS

The figures illustrate exemplary embodiments of the invention.

FIG. 1 shows a generic data processing system that may provide a suitable operating environment.

FIG. 2 shows a schematic graph illustrating a manufacturing process in accordance with an embodiment.

FIG. 3 shows an illustrative cost matrix corresponding to the graph shown in FIG. 2.

FIG. 4A shows illustrative pseudo-code for inverting the signs of the edge values of the graph of FIG. 2.

FIG. 4B shows illustrative pseudo-code for finding an optimal path in the graph of FIG. 2.

FIG. 5 shows a schematic graph illustrating a resulting longest path obtained by executing the pseudo-code of FIG. 4A and FIG. 4B.

FIG. 6 shows a schematic flowchart of a method in accordance with an embodiment.

### DETAILED DESCRIPTION OF THE INVENTION

As noted above, the present invention relates to a system and method for increasing usage of recycling in manufacturing processes.

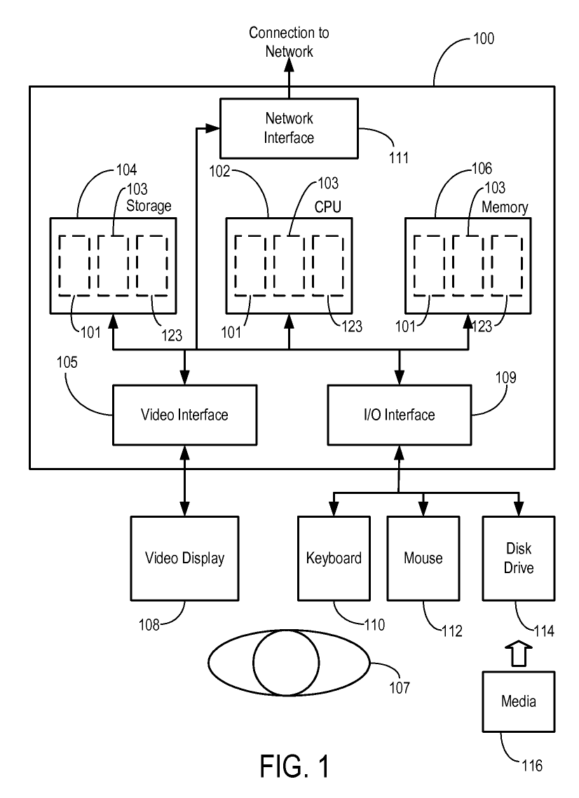

The invention may be practiced in various embodiments. A suitably configured data processing system, and associated communications networks, devices, software and firmware may provide a platform for enabling one or more of these systems and methods. By way of example, FIG. 1 shows a generic data processing system 100 that may include a central processing unit (“CPU”) 102 connected to a storage unit 104 and to a random access memory 106. The CPU 102 may process an operating system 101, application program 103, and data 123. The operating system 101, application program 103, and data 123 may be stored in storage unit 104 and loaded into memory 106, as may be required. An operator 107 may interact with the data processing system 100 using a video display 108 connected by a video interface 105, and various input/output devices such as a keyboard 110, mouse 112, and disk drive 114 connected by an I/O interface 109. In known manner, the mouse 112 may be configured to control movement of a cursor in the video display 108, and to operate various graphical user interface (GUI) controls appearing in the video display 108 with a mouse button. The disk drive 114 may be configured to accept data processing system readable media 116. The data processing system 100 may form part of a network via a network interface 111, allowing the data processing system 100 to communicate with other suitably configured data processing systems (not shown). The particular configurations shown by way of example in this specification are not meant to be limiting.

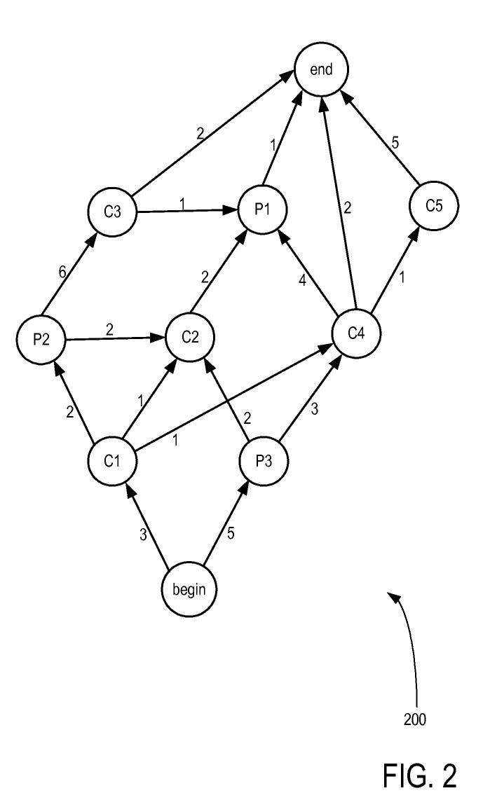

Now referring to FIG. 2, shown is a schematic graph 200 illustrating a system in accordance with an embodiment. The problem solved by this present invention is how to maximize the usage of recycling during a manufacturing process in order to minimize the environmental impact. This may be especially useful considering that the demand for products with recycled materials is constantly increasing, and the use of recycled materials may allow for significant savings in terms of energy and resources consumed. For example, manufacturing one ton of recycled paper may result in significantly less air pollution and less water pollution compared with usage of traditional raw materials.

The nodes of graph 200 represent various components C1, C2, C3, C4, C5 and various processes P1, P2, P3 that may be used during a product manufacturing process. Directed edges (shown in FIG. 2 as arrows) may connect the components and nodes, providing various paths that may be taken between a “begin” node and an “end” node. These various paths may represent alternative components and processes that may be used in order to manufacture a product. In an embodiment, each edge of the graph may have assigned to it a value indicative of a “benefit” associated with using recycled materials for a component, or by reusing something for a given process.

The “benefit” value assigned to each edge may be derived for example from empirical data collected in various studies or experiments based on knowledge of the environmental “benefit” value of recycling or reusing something for each component or process. As an illustrative example, in the packaging and shipping of manufactured parts, various recycled materials may be used in the packaging material. As well, such packaging material may be designed to be reused such that the packaging material is recycled diverted from landfill. In terms of processes, an example may be a process for reclaiming precious metals and other materials from electronic parts otherwise headed for landfill. The type and the quantity of material diverted from landfill by reuse or reclamation may be used to assign a relative environmental “benefit” of recycling for given component or process.

An analysis may also be performed on a component for recycled content, and a value may be assigned for the amount of recycled material used, or the amount of energy saved by not having to produce the material from scratch. A relative environmental “benefit” value may then be assigned to the component based on empirical data.

While preparing a schematic graph representation of various manufacturing process alternatives may take some effort, once the graph is created, the process of finding a possible solution for maximizing usage of recycling during a manufacturing process may then be greatly simplified.

After preparing a graph representation of various manufacturing process alternatives as described above, a modified Dijkstra's shortest path algorithm may be used in order to obtain the longest path in the graph. In an embodiment, Dijkstra's shortest path algorithm may be modified to run from the “end” node instead of the “begin” node (illustrated in FIG. 2). Assuming that the relative environmental “benefit” values have been assigned correctly, the resulting longest path then represents a manufacturing process involving the selection of components and processes that may maximize the usage of recycling during the manufacturing process. A more detailed description will now be provided.

For a given product or substance, a first step is to represent in a graph format known processes and components (or ingredients) for completing a manufacturing process. In the graph, each component and process is represented as a node, and directed edges connect some of the nodes. This is illustrated in graph 200 of FIG. 2, as discussed above. In graph 200, each possible path between the “begin” node and “end” node represents a possible manufacturing process that may form a product manufacturing cycle. All edges in the graph 200 have a value assigned, representing the environmental benefit value of recycling or reusing materials in various components or processing steps.

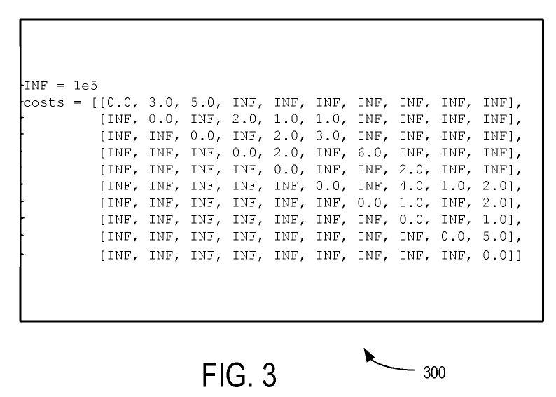

Now referring to FIG. 3, a “cost” matrix 300 may be developed for graph 200 of FIG. 2, with the “cost” in this case actually being the value representing the relative environmental benefit of recycling or reusing materials. As will be explained below, in order to take into account the inversion of “costs” and “benefits” in this case, the values in the cost matrix 300 may be inverted before a solution is sought. For the present example, cost matrix 300 shown in FIG. 3 includes values corresponding to the edge values between nodes. In this example, “INF” indicates that there is no edge or path provided between two given nodes. As the cost matrix 300 is strictly upper triangular, a sparse representation or other simplified form may be used.

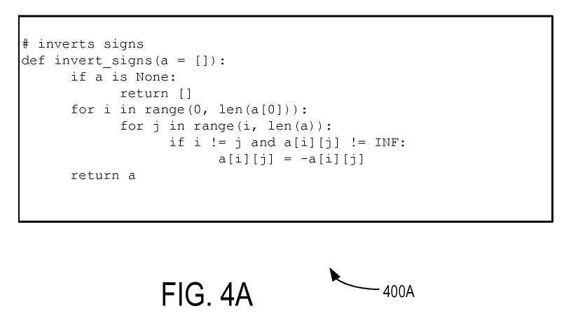

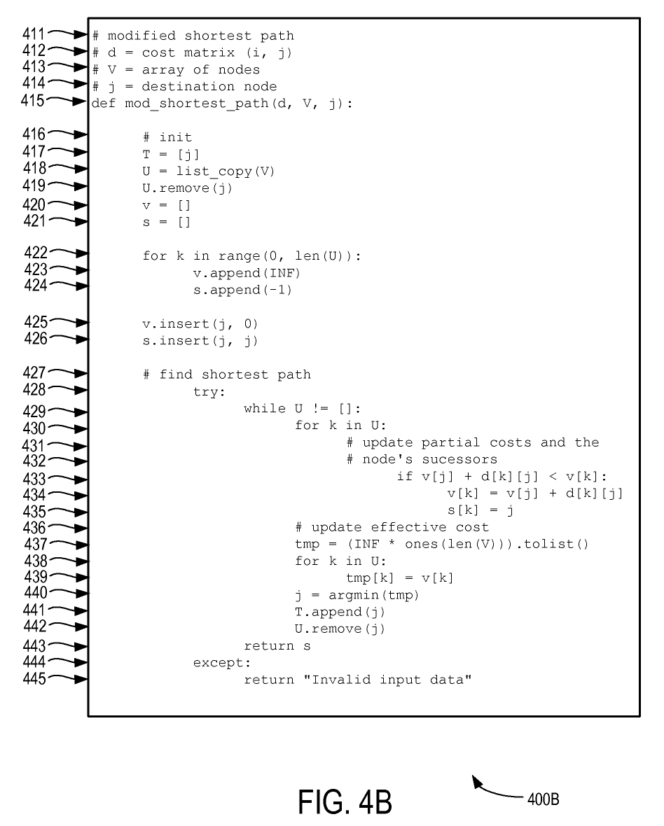

Now referring to FIG. 4A, an illustrative example of pseudo-code 400A for inverting the edge values representing environmental benefits. By inverting the element signs, the modified Dijkstra's shortest path algorithm may be used to calculate the longest path in the graph, rather than the shortest. This takes into account the inversion of “costs” and “benefits” by seeking a path that will result in maximized usage of recycling in the manufacturing process.

Now referring to FIG. 4B, an illustrative example of pseudo-code 400B for finding a longest path in graph 200 is shown. As noted earlier, this modified Dijkstra's shortest path algorithm runs from the destination node, and leads to the longest path in the graph from the “begin” node to the “end” node. The solution is found right after running the algorithm illustrated in lines 401 to 435.

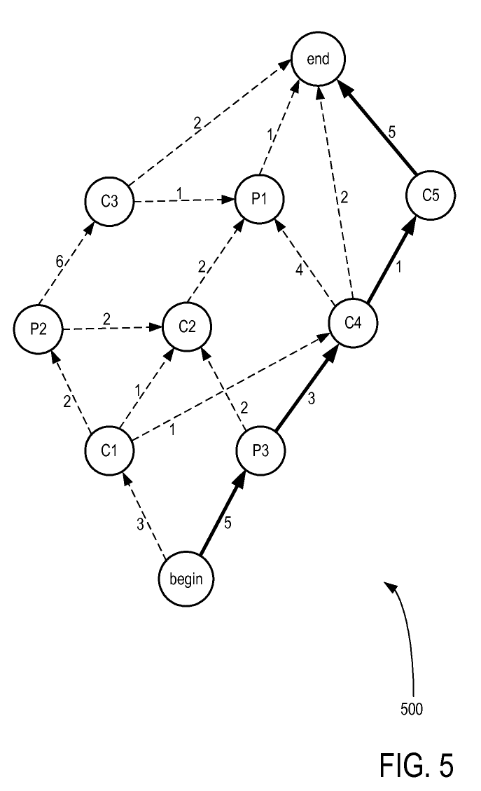

In the present illustrative example, pseudo-code 400 results in a solution in which the longest path includes P3, C4 and C5, as illustrated in FIG. 5. The optimal path may be highlighted, and in this illustrative example indicates that a product should be manufactured using process P3, and components C4 and C5 in order to maximize the usage of recycling. While this is a very simple illustrative example involving relatively few components and processes, it will be appreciated that this approach to maximizing usage of recycling may be extended to manufacturing processes involving any number of components and processes, connected by any number of edges with assigned edge values.

In an embodiment, the invention could be implemented on the data processing system 100 of FIG. 1, with a database stored in storage 104 and populated with the manufacturing components and processes, the edges linking the components and processes, and the corresponding “benefits”. The user may then add to or modify entries in the database to model the graph based on the best available information.

While an optimal solution may by calculated for a given graph model as described above, it will be appreciated that if new and better information is obtained for the relative value of an environmental “benefit”, or if new or improved components and/or processes are developed, the graph may be updated to include the new benefit values and the new components and processes to potentially arrive at a new optimal solution that may be an improvement over the original solution. Therefore, the system as described above may be used iteratively to continually improve a manufacturing process in order to maximize the usage of recycling.

In an embodiment, a suitable graphical user interface (GUI) may be provided such that the user may easily add, delete, or modify components, processes, edges and edge values in a graph using an intuitive graphical user interface. This may aid the user in modifying the graph with any new data, and running subsequent iterations of the modified Dijkstra's shortest path algorithm to further improve the manufacturing process to maximize usage of recycling.

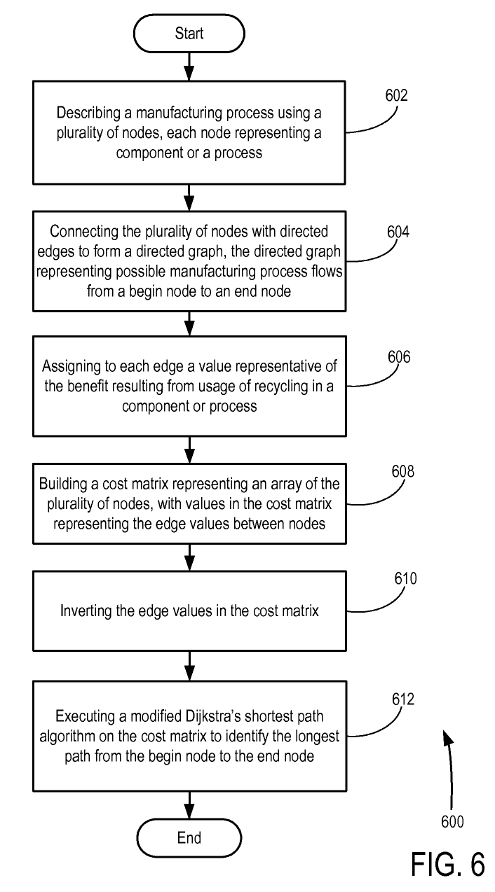

Now referring to FIG. 6, shown is an illustrative method 600 in accordance with an embodiment. As shown, method 600 begins at block 602, and describe a manufacturing process using a plurality of nodes, each node representing a component or a process.

Method 600 may then proceed to block 604, where method 600 may connect the plurality of nodes with directed edges to form a directed graph, the directed graph representing possible manufacturing process flows from a begin node to an end node.

Method 600 may then proceed to block 606, where method 600 may assign to each edge a value representative of the benefit resulting from usage of recycling in a component or process.

Method 600 then proceeds to block 608, where method 600 may build a cost matrix representing an array of the plurality of nodes, with values in the cost matrix representing the edge values between nodes.

Method 600 then proceeds to block 610, where in order to take into account the fact that the edge values represent a relative environmental “benefit” rather than an actual “cost”, the edge values in the cost matrix are inverted.

Alternatively, a user may simply be instructed to assign inverted values to edges in order to reflect a relative environmental “benefit”, in which case the inversion step at block 610 may be unnecessary.

Method 600 may then proceed to block 612, where method 600 may execute a modified Dijkstra's shortest path algorithm on the cost matrix to identify the longest path from the begin node to the end node. This longest path is the solution to maximizing usage of recycling during the manufacturing process. Method 600 then ends.

While various illustrative embodiments of the invention have been described above, it will be appreciated by those skilled in the art that variations and modifications may be made. Thus, the scope of the invention is defined by the following claims.

What is claimed is:

1. A method of optimizing a manufacturing process to increase usage of recycling in said manufacturing process, comprising:
describing the manufacturing process using a plurality of nodes, each node representing a component or a process;
connecting the plurality of nodes with directed edges to form a directed graph, the directed graph representing possible manufacturing process flows from a begin node to an end node;
assigning to each edge a value representative of a benefit resulting from usage of recycling in a component or process; and
determining a longest path from the begin node to the end node in the directed graph to identify a manufacturing process flow maximizing usage of recycling in the manufacturing process.

2. The method of claim 1, wherein the method further comprises:
building a cost matrix representing an array of the plurality of nodes, with values in the cost matrix representing the edge values between nodes;
inverting the edge values in the cost matrix; and
executing a modified Dijkstra's shortest path algorithm, wherein the algorithm is run from the end node instead of the begin node, to determine the longest path from the begin node to the end node in the directed graph.

3. The method of claim 2, further comprising identifying the nodes in the longest path, and presenting an ordered combination of any components or processes in the longest path as the solution for maximizing usage of recycling in the manufacturing process.

4. The method of claim 2, further comprising modifying the directed graph to incorporate new information by adding or deleting nodes or edges, and by adding or modifying edge values.

5. The method of claim 4, further comprising providing a graphical user interface adapted to allow a user to modify the directed graph by adding or deleting node objects or edge objects, and by adding or modifying edge values associated with the edge objects.

6. The method of claim 5, further comprising converting the directed graph in the graphical user interface into a new cost matrix.

7. The method of claim 6, further comprising re-executing the modified Dijkstra's shortest path algorithm on the new cost matrix to identify the longest path from the begin node to the end node.

8. A system for optimizing a manufacturing process to increase usage of recycling in a manufacturing process, comprising:
means for describing the manufacturing process using a plurality of nodes, each node representing a component or a process;
means for connecting the plurality of nodes with directed edges to form a directed graph, the directed graph representing possible manufacturing process flows from a begin node to an end node;
means for assigning to each edge a value representative of a benefit resulting from usage of recycling in a component or process; and
means for determining a longest path from the begin node to the end node in the directed graph to identify a manufacturing process flow maximizing usage of recycling in the manufacturing process.

9. The system of claim 8, wherein the method further comprises:
means for building a cost matrix representing an array of the plurality of nodes, with values in the cost matrix representing the edge values between nodes;
means for inverting the edge values in the cost matrix; and
means for executing a modified Dijkstra's shortest path algorithm, wherein the algorithm is run from the end node instead of the begin node, to determine the longest path from the begin node to the end node in the directed graph.

10. The system of claim 9, further comprising means for identifying the nodes in the longest path, and presenting an ordered combination of any components or processes in the longest path as the solution for maximizing usage of recycling in the manufacturing process.

11. The system of claim 9, further comprising means for modifying the directed graph to incorporate new information by adding or deleting nodes or edges, and by adding or modifying edge values.

12. The system of claim 11, further comprising means for providing a graphical user interface adapted to allow a user to modify the directed graph by adding or deleting node objects or edge objects, and by adding or modifying edge values associated with the edge objects.

13. The system of claim 12, further comprising means for converting the directed graph in the graphical user interface into a new cost matrix.

14. The system of claim 13, further comprising means for re-executing the modified Dijkstra's shortest path algorithm on the new cost matrix to identify the longest path from the begin node to the end node.

15. A data processor readable medium storing data processor code that when loaded onto and executed by a data processing device adapts the device to execute a method of optimizing a manufacturing process to increase usage of recycling in a manufacturing process, the data processor readable medium comprising:
code for describing the manufacturing process using a plurality of nodes, each node representing a component or a process;
code for connecting the plurality of nodes with directed edges to form a directed graph, the directed graph representing possible manufacturing process flows from a begin node to an end node;
code for assigning to each edge a value representative of a benefit resulting from usage of recycling in a component or process; and
code for determining a longest path from the begin node to the end node in the directed graph to identify a manufacturing process flow maximizing usage of recycling in the manufacturing process.

16. The data processor readable medium of claim 15, further comprising:
code for building a cost matrix representing an array of the plurality of nodes, with values in the cost matrix representing the edge values between nodes;
code for inverting the edge values in the cost matrix; and
code for executing a modified Dijkstra's shortest path algorithm, wherein the algorithm is run from the end node instead of the begin node, to determine the longest path from the begin node to the end node in the directed graph.

17. The data processor readable medium of claim 16, further comprising code for identifying the nodes in the longest path, and presenting an ordered combination of any components or processes in the longest path as the solution for maximizing usage of recycling in the manufacturing process.

18. The data processor readable medium of claim 16, further comprising code for modifying the directed graph to incorporate new information by adding or deleting nodes or edges, and by adding or modifying edge values.

19. The data processor readable medium of claim 18, further comprising code for providing a graphical user interface adapted to allow a user to modify the directed graph by adding or deleting node objects or edge objects, and by adding or modifying edge values associated with the edge objects.

20. The data processor readable medium of claim 19, further comprising code for converting the directed graph in the graphical user interface into a new cost matrix.

21. The data processor readable medium of claim 20, further comprising code for re-executing the modified Dijkstra's shortest path algorithm on the new cost matrix to identify the longest path from the begin node to the end node.
